(19) United States
(12) Patent Application Publication
(10) Pub. No.: US 2007/0094541 A1
(43) Pub. Date: Apr. 26, 2007

(54) METHOD AND APPARATUS FOR GENERATING TEST EXECUTION SEQUENCES AUTOMATICALLY FOR A SOFTWARE TESTING PROCESS

(76) Inventor: Hua Kang, Beijing (CN)

Correspondence Address: HOFFMAN, WARNICK & D'ALESSANDRO LLC, 75 STATE ST, 14TH FLOOR, ALBANY, NY, 12207, US

(21) Appl. No.: 11/531,421

(22) Filed: Sep. 13, 2006

(30) Foreign Application Priority Data
Oct. 25, 2005 (CN) 200510116934.2

(51) Int. Cl. G06F 11/00

(52) U.S. Cl. 714/38

(57) ABSTRACT

The present invention provides a method for generating test execution sequences automatically for a software testing process. A method in accordance with an embodiment of the present invention includes: inputting scripts of test cases; generating test execution sequences based on the scripts; and selecting valid test execution sequences according to predetermined criteria to generate final test execution sequences. With this invention, test execution sequences with a plurality of test cases may be generated automatically, so as to improve the ability of finding bugs in a software being tested in automatic software testing.

### FIELD OF THE INVENTION

The present invention relates to the field of software testing, and more specifically, to a method and apparatus for generating a test execution sequence automatically for a software testing process.

### BACKGROUND OF THE INVENTION

A software test is a process during which various functions of the software are tested to find bugs. To this extent, a software test tool needs to have a lot of test cases and complete various tests automatically. In most of the existing automated test tools, such as RFT (Rational Functional Tester) and RTM (Rational Test Manager) of IBM Corporation, usually a test case is automatically executed individually. Thus, as the software products become more and more mature, it is not easy to find bugs when executing test cases individually. In fact, if some execution sequences of test cases can be generated automatically according to requirements and the test cases be executed automatically according to the execution sequences, critical bugs existing in the software can be found conveniently. However, in most of the automated test tools there are no tools for generating test execution sequences automatically for the software testing process. Thus, testers need such tools to provide as many test execution sequences as possible for a software testing process so as to find more bugs in the software.

### SUMMARY OF THE INVENTION

The present invention provides a method and apparatus for generating test execution sequences automatically for a software testing process.

According to an aspect of the invention, there is provided a method for generating test execution sequences automatically for a software testing process, comprising: inputting scripts of test cases; generating test execution sequences based on the scripts; and selecting valid test execution sequences according to predetermined criteria to generate final test execution sequences.

According to another aspect of the invention, there is provided an apparatus for generating test execution sequences, comprising: an input unit configured to input scripts of test cases; a test execution sequence generator configured to generate test execution sequences from the inputted scripts; and a test execution sequence filter configured to select valid test execution sequences based on predetermined criteria to generate final test execution sequences.

### BRIEF DESCRIPTION OF THE DRAWINGS

These and other features of this invention will be more readily understood from the following detailed description of the various aspects of the invention taken in conjunction with the accompanying drawings.

FIG. 1 is a flowchart showing an illustrative method for generating test execution sequences automatically for a software testing process according to an embodiment of the invention.

FIG. 2 illustrates an example for generating test execution sequences based on a model according to the invention.

FIG. 3 is a flowchart showing a method for generating test execution sequences automatically for a software testing process according to another embodiment of the invention.

FIG. 4 is a schematic block diagram showing an apparatus for generating test execution sequences according to an embodiment of the invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

In the invention, by “a test case” is meant a description of the functions to be tested of the software being tested; by “a script” is meant a program for implementing test cases; and by “a test execution sequence” is meant a sequence for invoking scripts.

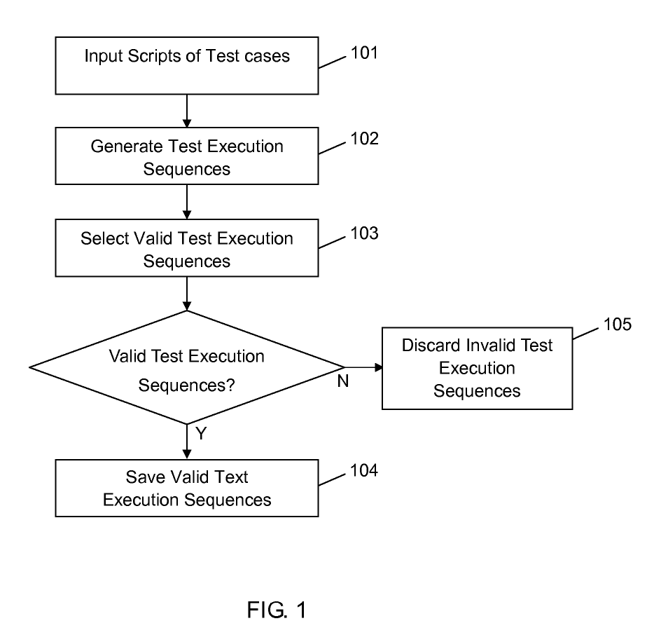

FIG. 1 is a flowchart showing a method for generating a test execution sequence automatically for a software testing process according to an embodiment of the invention.

As shown in FIG. 1, in Step 101, scripts of test cases, i.e. test scripts, are inputted. Usually in a testing tool test scripts can be generated automatically, and the tester only needs to select the needed test scripts. In addition, in this step, the number of running cycles of the test scripts, i.e. the number of runs of the test scripts, may also be inputted for selecting valid test execution sequences in the subsequent steps.

Next, in Step 102, test execution sequences are generated based on the inputted scripts. Methods for generating test execution sequences can include, for example:

1) A sequential generation method, including the steps of: arranging the test scripts in the initial order in which the test scripts are inputted and taking this sequence as the first test execution sequence; then, changing the first test script in the first test execution sequence one by one to generate other test execution sequences. In this way, the number of generated test execution sequences is the same as the number of the inputted test scripts. For instance, if in Step 101 the test scripts {“testcase1”, “testcase2”, “testcase3”, “testcase4”} are inputted, then the test execution sequences generated with the sequential generation method will be:

1^{st} test execution sequence: testcase1, testcase2, testcase3, testcase4;

2^{nd} test execution sequence: testcase2, testcase3, testcase4 testcase1;

3^{rd} test execution sequence: testcase3, testcase4, testcase1, testcase2;

4^{th} test execution sequence: testcase4, testcase1, testcase2, testcase3.

2) A random generation method including randomly generating test execution sequences, wherein the number of generated test execution sequences is the factorial of the number of inputted test scripts. In the above example, if the random generation method is used, the generated test execution sequences are:

1^{st} test execution sequence: testcase1, testcase4, testcase3, testcase2;

2^{nd} test execution sequence: testcase2, testcase1, testcase4 testcase3;

. . .

24^{th} test execution sequence: testcase4, testcase2, testcase1, testcase3;

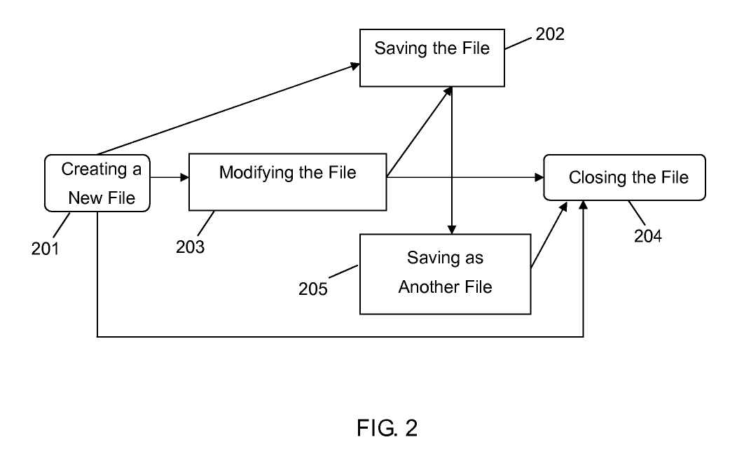

3) A model based generation method based on a behavior model of the software being tested, wherein test execution sequences are generated according to the sequences that conform with the system logic of the behavior model. As such, in Step 101, it is required to input the behavior model of the software being tested. For instance, an illustrative behavior model of the software being tested is shown in FIG. 2, having the following behaviors: creating a file 201, saving the file 202, modifying the file 203, closing the file 204 and saving as another file 205. Then, the test execution sequences generated using the model based generation method are:

1^{st} test execution sequence: creating a file, modifying the file, saving the file, closing the file;

2^{nd} test execution sequence: creating a file, modifying the file, saving as another file, closing the file;

3^{rd} test execution sequence: creating a file, closing the file;

4^{th} test execution sequence: creating a file, saving the file, closing the file;

5^{th} test execution sequence: creating a file, modifying the file, saving the file, saving as another file, closing the file.

After test execution sequences are generated, in order to make the generated test execution sequences more reasonable, Step 103 is performed to select valid test execution sequences according to predetermined criteria to generate the final test execution sequences. In this embodiment, the following three methods are provided for selecting valid test execution sequences.

The first method: the predetermined criteria are test execution sequences that are defined as those which should not be included based on the functions of the software being tested. The test execution sequences that should not be included are then excluded from the test execution sequences generated in Step 105.

The second method: the predetermined criteria are the priorities of the test cases, a test case with higher priority being executed earlier, and a test case with lower priority being executed later. Valid test execution sequences are selected from the test execution sequences generated in Step 103 based on the priorities of the test cases in descending order.

The third method: the predetermined criteria are logic sequences of the test cases; test execution sequences that are consistent with the logic sequences are selected as the final test execution sequences. For instance, the test case “saving a file” must be executed before the test case “saving as another file”, so the test execution sequences that are consistent with this logic sequence should be selected.

The above three kinds of methods may be used either individually or in any combination.

If the number of running cycles of the test scripts is inputted in Step 101, then after selecting valid test execution sequences by using any of the above-mentioned methods or a combination thereof, the number of running cycles should be used as the number of the final test execution sequences to further select test execution sequences. For instance, if the inputted test scripts are {“testcase1”, “testcase2”, “testcase3”, “testcase4”} and the number of running cycles is 4, and the random generation method was used to generate test execution sequences, then after the selection in Step 103, if the number of the test execution sequences is larger than 4, it is needed to further select the first 4 test execution sequences sequentially or select 4 test execution sequences randomly as the final test execution sequences.

In Step 104, the selected valid test execution sequences are saved as the final test execution sequences. In Step 105, the test execution sequences that were not selected are discarded.

Although in the above description a test script is a single program for implementing certain test function, a test script set including a plurality of test scripts for implementing a test function as a whole is also applicable to the above methods.

From the above description it can be seen that by using this embodiment it is possible to generate test execution sequences with a plurality of test cases, so as to enhance the ability of finding bugs in the software being tested. Further, in this embodiment, if the test tool is a test tool based on API (Application Programming Interface), such as IBM Corporation's RFT, the steps of generating and selecting test execution sequences of the present invention may be packaged as JAVA API, enabling the tester to use the API directly in the test case scripts, so that the tester may obtain the final test execution sequences conveniently based on the test scripts or test script sets for different test purposes, thus realizing automatic testing (Java and all Java-based trademarks are trademarks of Sun Microsystems, Inc. in the United States, other countries, or both).

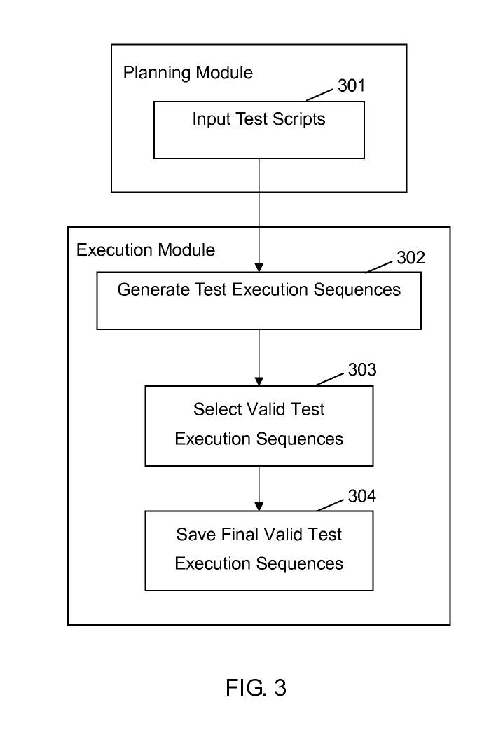

FIG. 3 is a flowchart showing a method for generating test execution sequences automatically for a software testing process according to another embodiment of the invention. In this embodiment, a scenario where the test tool is based on GUI (Graphic User Interface) is described. For instance, the test tool may be IBM Corporation's RTM, which includes a planning module, an execution module, a result module and an analysis module, wherein the planning module is used for organizing test cases and test data; the execution module is used for organizing the execution of test cases and test scripts and for organizing the test cases and test scripts into test sets for testing; the result module is used for saving and managing the running result of each execution; and the analysis module is used for outputting a test report. By using this test tool, the steps of generating and selecting test execution sequences of the present invention may be integrated into the execution module and provided to the tester through a GUI.

As shown in FIG. 3, in Step 301, test scripts are inputted into the planning module for organizing the test scripts, the step being substantially the same as Step 101 in the earlier described embodiment. Then, in Step 302, test execution sequences are generated based on the test scripts, wherein the method for generating test execution sequences may be any of the sequential generation method, random generation method and model based generation method as described above. In Step 303, valid test execution sequences are selected from the generated test execution sequences according to predetermined criteria, so as to generate the final test execution sequences, wherein the selection method in this step is the same as that in Step 110 of the earlier described embodiment. The above Steps 302 and 303 are performed in the execution module of RTM.

If a number of running cycles of test scripts is inputted in Step 301, then after Step 303, the number of running cycles is used as the number of the final test execution sequences to further select test execution sequences.

Further, in Step 304, the final test execution sequences are saved for later reuse by the tester.

From the above description it can be seen that by using this embodiment it is possible to generate, from individual test cases, test execution sequences each having a plurality of test cases, and provide these sequences to a tester through GUI, enabling the tester to realize automatic testing of software through menus and dialogues.

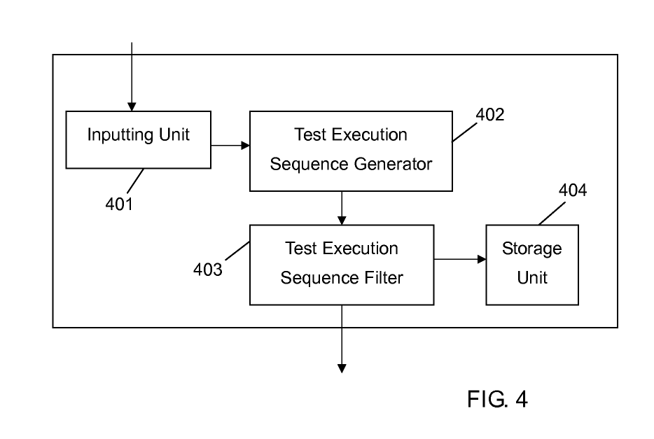

FIG. 4 is a schematic block diagram showing an apparatus for generating test execution sequences according to an embodiment of the invention. As shown in FIG. 4, the apparatus for generating test execution sequences comprises: an input unit 401 configured to input scripts of test cases and/or the number of running cycles of the scripts and/or a behavior model of the software being tested; a test execution sequence generator 402 configured to generate test execution sequences based on the inputted scripts; and a test execution sequence filter 403 configured to select valid test execution sequences based on predetermined criteria to generate the final test execution sequences.

After inputting test scripts and/or the number of running cycles of the scripts through the input unit 401, the test execution sequence generator 402 may arrange the test scripts in the initial input order of the test scripts and take this sequence as the first test execution sequence, then change the first test script in the first test execution sequence one by one to generate other test execution sequences; or may randomly generate test execution sequences based on the inputted test scripts; or may generate test execution sequences according to the sequences that conform with the system logic of a behavior model of the software being tested. The generated test execution sequences are outputted to the test execution sequence filter 403.

Then, the test execution sequence filter 403 excludes the test execution sequences that are defined as should not be included based on the functions of the software being tested from the test execution sequences generated by the test execution sequence generator 402 and the remaining test execution sequences are taken as valid test execution sequences.

Alternatively, the test execution filter 403 selects valid test execution sequences based on the priorities of the test cases, wherein the priorities of the test cases are determined based on the functions of the software being tested and the properties of the test cases themselves, and a test case with higher priority will be executed prior to a test case with lower priority.

Alternatively, the test execution sequence filter 403 selects the test execution sequences that are consistent with the logic sequences of the test cases as valid test execution sequences.

The test execution sequence filter 403 may further select the selected test execution sequences according to the inputted number of running cycles of the test scripts to generate the final test execution sequences.

Furthermore, the apparatus for generating software test execution sequences may further comprise a storage unit 404 configured to store the final test execution sequences.

From the above description it can be seen that test execution sequences with a plurality of test scripts may be generated using the apparatus of this embodiment for generating software test execution sequences so as to raise the efficiency of software testing.

The foregoing description of the preferred embodiments of this invention has been presented for purposes of illustration and description. It is not intended to be exhaustive or to limit the invention to the precise form disclosed, and obviously, many modifications and variations are possible.

What is claimed is:

1. A method for generating test execution sequences automatically for a software testing process, comprising:
inputting scripts of test cases;
generating test execution sequences based on the scripts; and
selecting valid test execution sequences according to predetermined criteria to generate final test execution sequences.

2. The method of claim 1, wherein the step of generating test execution sequences based on the scripts generates the test execution sequences based on a sequential generation method.

3. The method of claim 1, wherein the step of generating test execution sequences based on the scripts generates the test execution sequences based on a random generation method.

4. The method of claim 1, wherein the step of generating test execution sequences based on the scripts generates the test execution sequences based on a behavior model of the software being tested.

5. The method of claim 1, wherein,
the predetermined criteria are test execution sequences that should not be included based on the functions of the software being tested; and
the step of selecting valid test execution sequences according to predetermined criteria further comprises excluding the test execution sequences that should not be included from the generated test execution sequences.

6. The method of claim 1, wherein,
the predetermined criteria are priorities of the test cases, and the test cases are executed in descending order of priority; and
the step of selecting valid test execution sequences according to predetermined criteria further comprises: selecting the valid test execution sequences based on the priorities of the test cases in descending order.

7. The method of claim 1, wherein,
the predetermined criteria are logic sequences of the test cases; and
the step of selecting valid test execution sequences according to predetermined criteria further comprises: selecting the test execution sequences consistent with the logic sequences.

8. The method of claim 1, further comprising:
inputting a number of running cycles of the scripts of test cases; and
selecting valid test execution sequences according to predetermined criteria and the number of running cycles to generate the final test execution sequences.

9. The method of claim 1, further comprising: saving the final test execution sequences for reuse.

10. An apparatus for generating test execution sequences, comprising:
an input unit configured to input scripts of test cases;
a test execution sequence generator configured to generate test execution sequences from the inputted scripts; and
a test execution sequence filter configured to select valid test execution sequences based on predetermined criteria to generate final test execution sequences.

11. The apparatus of claim 10, wherein the test execution sequence generator generates test execution sequences based on a sequential generation method.

12. The apparatus of claim 10, wherein the test execution sequence generator generates test execution sequences based on a random generation method.

13. The apparatus of claim 10, wherein the test execution sequence generator generates test execution sequences based on a behavior model of the software being tested.

14. The apparatus of claim 10, wherein the test execution sequence filter excludes test execution sequences that should not be included from the generated test execution sequences based on functions of the software being tested.

15. The apparatus of claim 10, wherein the test execution sequence filter selects valid test execution sequences based on priorities of the test cases in descending order.

16. The apparatus of claim 10, wherein the test execution sequence filter selects the test execution sequences that are consistent with logic sequences of the test cases.

17. The apparatus of claim 10, further comprising a storage unit configured to store the final test execution sequences.

18. A computer program product for generating test execution sequences automatically for a software testing process, the computer program product comprising a computer readable medium having computer readable program code, which when executed, performs the steps of:
inputting scripts of test cases;
generating test execution sequences based on the scripts; and
selecting valid test execution sequences according to predetermined criteria to generate final test execution sequences.
